(19) United States
(12) Patent Application Publication
(10) Pub. No.: US 2025/0266009 A1
(43) Pub. Date: Aug. 21, 2025

(54) Apparatus and Method for Driving Display and Computer Program Product thereof

(71) Applicant: MediaTek Singapore Pte. Ltd., Singapore (SG)

(72) Inventors: Mingjin Ge, Hefei (CN); Xin Lin, Hefei (CN)

(73) Assignee: MediaTek Singapore Pte. Ltd., Singapore (SG)

(21) Appl. No.: 18/444,781

(22) Filed: Feb. 19, 2024

(51) Int. Cl. G09G 3/34; G09G 3/20

(52) U.S. Cl. CPC G09G 3/344; G09G 3/2014; G09G 2310/06

(57) ABSTRACT

Provided is an apparatus for driving a display having a display unit, an image data storage, a lookup storage, a waveform generation unit, and a processing unit. The display unit may operate a microcapsule. The image data storage may store current and next grayscale data of the microcapsule. The lookup storage may look up a first waveform dataset corresponding to the current and next grayscale data. The waveform generation unit may generate a second waveform dataset from the first waveform dataset. The processing unit may drive the display unit to apply voltage to the microcapsule according to the second waveform dataset. Also provided is a method for driving a display, which includes providing the apparatus for driving the display, and having the display unit to operate the microcapsule according to the current grayscale data. Further provided is a computer program product adapted to perform the method.

### BACKGROUND

This invention is related to the electrophoretic display (EPD) processing technique, more particularly, to an apparatus and a method for driving a display, and a computer program product thereof.

Electrophoretic display (EPD) is a type of electronic paper display that imitates appearance of ordinary ink on a regular paper. FIG. 1 is an exemplary structure of a typical EPD 1. In particular, the typical EPD 1 may contain a plurality of microcapsules 10 (only one is shown for brevity) having black particles 12 carrying positive charges and white particles 13 carrying negative charges respectively. While black particles 12 and white particles 13 are floating within liquid 11 of the microcapsule 10, they may be drawn to desired position based on electric fields applied to the location of the microcapsule 10, thus making the microcapsule 10 to appear as a color of a desired grayscale level. For example, if a voltage is applied across a top electrode 1A and a bottom electrode 1B, negative charges may be accumulated at the top electrode 1A and positive charges may be accumulated at the bottom electrode 1B, drawing the black particles 12 upward and the white particles 13 downward owing to attraction of opposite charges. The level of the voltage may affect the quantities of charges accumulated at the top electrode 1A and the bottom electrode 1B, thereby drawing the black particles 12 and the white particles 13 to the desired positions in the microcapsule 10, resulting in the desired grayscale level.

For the microcapsule 10 to present color of desired grayscale level, a pulse-width modulation (PWM) technique may be utilized by applying predetermined voltages to the microcapsule 10 according to a predetermined PWM waveform across a plurality of frames in time and allowing the microcapsule 10 (and accordingly, the black particles 12 and the white particles 13 contained within) to erase its current grayscale level, return to a default grayscale level (e.g., to a lightest grayscale level or a darkest grayscale level), and drive to a desired grayscale level. That is, the longer the travel distance for the black particles 12 and the white particles 13 to travel to desired floating positions in the microcapsule 10, the more frames will be needed for the predetermined PWM waveform to drive the black particles 12 and the white particles 13, and the time required for transforming the microcapsule 10 from a current grayscale level to a next grayscale level is thus increased.

There is a need in the EPD market to increase hardware capability and speed up the response time of the electronic paper display.

### SUMMARY

According to an embodiment of the invention, an apparatus for driving a display includes a display unit, an image data storage, a lookup storage, a waveform generation unit coupled to the lookup storage, and a processing unit coupled to the image data storage, the waveform generation unit and the display unit. The display unit is used to operate a microcapsule. The image data storage is used to store current grayscale data and next grayscale data of the microcapsule. The lookup storage is used to look up a first waveform dataset corresponding to the current grayscale data and the next grayscale data. The waveform generation unit is used to generate a second waveform dataset based on the first waveform dataset. The processing unit is used to drive the display unit to apply a voltage to the microcapsule according to the second waveform dataset.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a typical electrophoretic display.

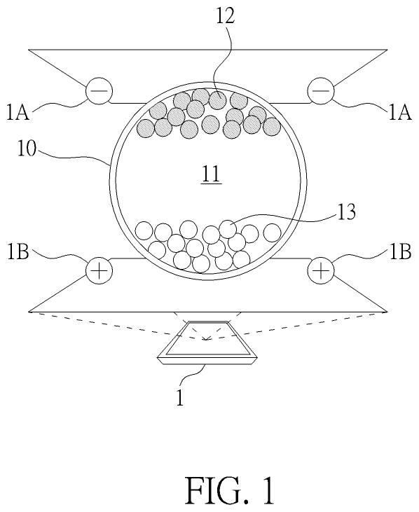

FIG. 2 is a schematic diagram of an apparatus for driving a display in accordance to embodiments of the present application.

FIG. 3 is a flowchart of a method for driving a display in accordance to embodiments of the present application.

FIG. 4 is a schematic diagram of details regarding a first waveform dataset acquired by a lookup storage.

FIG. 5 is a schematic diagram of details regarding a second waveform dataset generated by a waveform generation unit.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

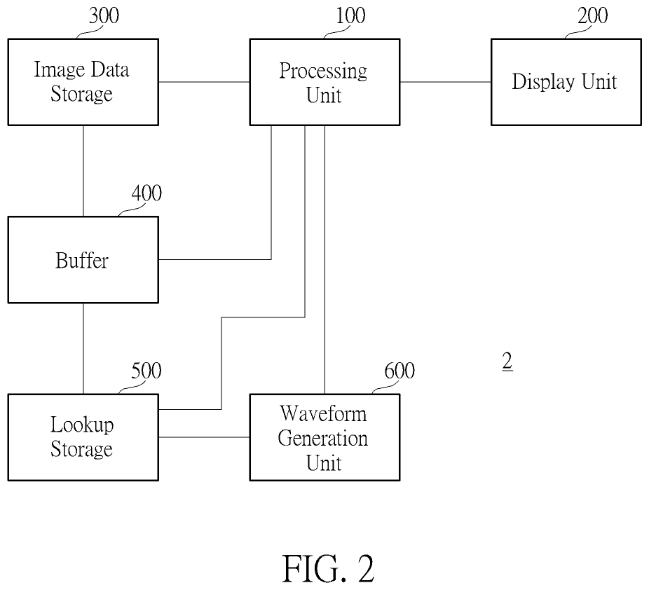

FIG. 2 is a schematic diagram of apparatus 2 for driving a display unit 200 according to an embodiment of the present invention. Apparatus 2 may include a processing unit 100, a display unit 200, an image data storage 300, a buffer 400, a lookup storage 500 and a waveform generation unit 600. Said components of apparatus 2 may be embedded in an electrophoretic display (EPD), and may be coupled to each other via any suitable wired or wireless connection, of which the present: invention is not limited thereto. Further, the configuration of the components of apparatus 2 may be modified without departing from the operating principle of the present invention. For example, any two or more of the processing unit 100, the display unit 200, the image data storage 300, the buffer 400, the lookup storage 500 and the waveform generation unit 600 may be integrated as one component instead of individual components.

The processing unit 100 may be a controller such as a microcontroller, and may be configured to drive the display unit 200 to operate and display a desired image.

The display unit 200 may be coupled to the processing unit 100, and may be implemented as a thin film transistor (TFT) based display, driving (e.g., by applying voltages to) color particles (e.g., black and white particles and/or particles in other colors) of microcapsules embedded therein to respectively present a color of a desired grayscale level according to the desired image.

The image data storage 300 may be coupled to the processing unit 100, and may be implemented as any specific type of storage medium configured to store image data (and accordingly, grayscale data corresponding to image data) to be displayed by the display unit 200.

The buffer 400 may be coupled to the image data storage 300, and may be a storage medium that is the same as or different from the image data storage 300. The buffer 400 may temporarily store the image data (and the corresponding grayscale data) regarding a current image and a next image upon instruction (e.g., an instruction to switch the image displayed by the display unit 200) passed down by the processing unit 100.

The lookup storage 500 may be coupled to the buffer 400, and may be implemented as a storage medium that is the same as or different from the image data storage 300 and/or the buffer 400. The lookup storage 500 may store frame lookup tables regarding voltage waveforms required for transforming a current grayscale level of a particular microcapsule embedded in the display unit 200 to a next grayscale level. For example, when the processing unit 100 passes down an instruction to switch an image displayed by the display unit 200, the lookup storage 500 may look up the frame lookup tables frame by frame according to the current image data and the next image data stored in the buffer 400, so as to inquire the voltage waveforms needed to transform each and every of the microcapsules embedded in the display unit 200 from a current grayscale level (as indicated in the current image data) to a next grayscale level (as indicated in the next image data) to complete the image switch. Each frame may have a fixed length of duration. The lookup result by the lookup storage 500 may be output as digital datasets corresponding to the voltage waveforms (referred to as “first waveform dataset” hereafter) and transmitted to the waveform generation unit 600.

The waveform generation unit 600 may be coupled to the lookup storage 500, and may be implemented as any type of digital electronics configured to take the first waveform datasets (e.g., each microcapsule embedded in the display unit 200 has a corresponding first waveform dataset) from the lookup storage 500 and generate as second waveform datasets (e.g., each microcapsule embedded in the display unit 200 has a corresponding second waveform dataset). The second waveform datasets may be sent by the waveform generation unit 600 back to the processing unit 100, which will then drive the display unit 200 to apply voltages to the microcapsules according to the second waveform datasets and respectively drive the microcapsules to transform their grayscale levels.

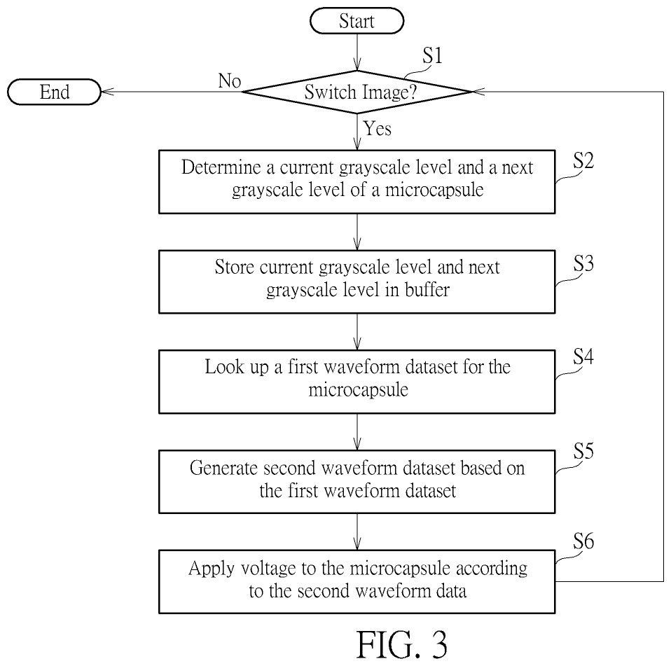

Now refer to FIG. 3, where a flowchart for performing a method for driving a display unit 200 is shown. For brevity, the method is described under a scenario where a grayscale level transformation (from the current grayscale level to the next grayscale level) is conducted on one microcapsule embedded in the display unit 200. However, a skilled artisan in the art would understand that in order to complete image switching, the method may be conducted on all microcapsules embedded in the display unit 200 concurrently or in any preferred order, regardless of the grayscale levels being involved in the grayscale level transformations.

At Step S1, the method is started by turning on apparatus 2 to display a blank image (i.e., the display unit 200 has yet to display anything) or to display a current image (i.e., the microcapsule is being operated according to a current grayscale level). Then, the processing unit 100 determines whether a condition for image switching is triggered. For example, a user may operate a user interface on the display unit 200 and trigger (e.g., tap on the user interface) a command to switch the current image to the next image. If Step S1 is determined as “yes”, then the method will proceed to Step S2; and if Step S1 is determined as “no”, then the method will be terminated.

At Step S2, processing unit 100 determines (from the image data storage 300) the current grayscale data and the next grayscale data for the microcapsule. As used herein, the current grayscale data corresponds to a current grayscale level of the microcapsule and constitutes the current image data displayed by the display unit 200, while the next grayscale data corresponds to the next grayscale level of the microcapsule and constitutes the next image data to be displayed by the display unit 200. The current grayscale data and the next grayscale data may each have K possible grayscale levels (e.g., K=16 for the current grayscale data and the next grayscale data to respectively have 16 possible grayscale levels).

At Step S3, upon receiving an instruction from processing unit 100, the image data storage 300 stores the current grayscale data and the next grayscale data of the microcapsule into buffer 400 for subsequent processing.

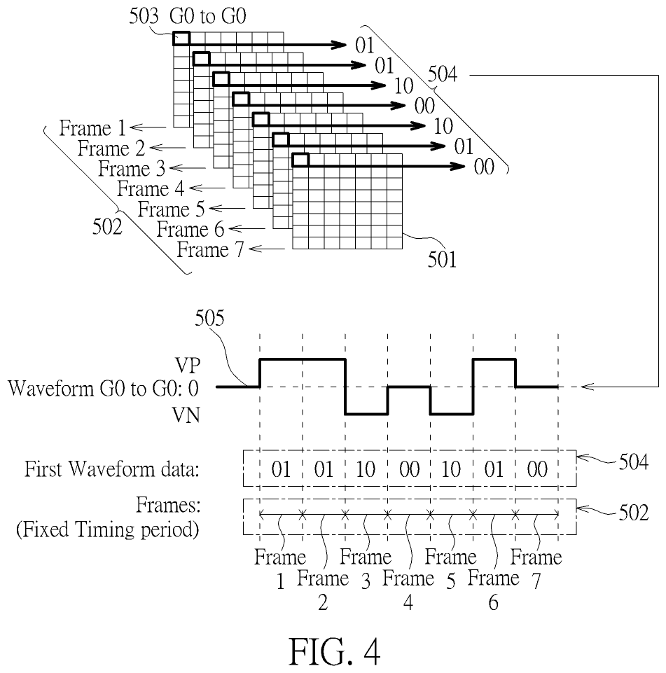

At Step S4, upon receiving an instruction from the processing unit 100, the lookup storage 500 looks up the frame lookup tables stored therein to determine a first waveform dataset for the microcapsule according to the current grayscale data and the next grayscale data stored in the buffer 400. The first waveform dataset may include N pieces of first waveform data, each piece of first waveform data corresponding to a frame, N being a positive integer. For example, if N=7, the first waveform dataset may include 7 pieces of first waveform data for applying voltages in 7 consecutive frames. Details of Step S4 are now discussed with reference to FIG. 4.

FIG. 4 shows an exemplary schematic of generation of the first waveform dataset including 7 pieces of first waveform data, the 7 pieces of first waveform data corresponding to 7 consecutive frames 502, respectively. As shown, the lookup storage 500 may store 7 frame lookup tables 501, where the frame lookup tables 501 may each correspond to a frame 502 of the first waveform dataset. Each of the frame lookup table 501 may be a matrix including K×K cells indexed by the current grayscale data and the next grayscale data, where K is the quantity of the possible grayscale levels of the current grayscale data and the next grayscale data. Each cell contains a frame value 503 represented by M bits (e.g., M=2 for a frame value 503 of 2 bits). For example, if K=16, each of the frame lookup tables 501 may be a 16×16 matrix indexed by 16 possible grayscale levels of the current grayscale data and 16 possible grayscale levels of the next grayscale data. The lookup storage 500 may search the frame lookup tables 501 of the 7 frames 502 according to the current grayscale data and the next grayscale data to obtain 7 frame values 503 of the 7 pieces of first waveform data, respectively. The frame value 503 may represent a voltage to be applied to the microcapsule in the corresponding frame 502 during the grayscale level transformation. For example, the frame value 503 “01” may represent a high (positive) voltage level VP (e.g., VP=3.3V), the frame value 503 “10” may represent a low (negative) voltage level VN (e.g., VN=−3.3V), and the frame value 503 “00” may represent a ground voltage level (=0V).

In an example, the 16 possible grayscale levels may be grayscale levels G0 to G15, with the grayscale level G0 being the lowest grayscale level and the grayscale level G15 being the highest grayscale level. The current grayscale data may be the grayscale level G0 and the next grayscale data may also be the grayscale level G0. That is, for a grayscale level transformation from the current grayscale data “G0” to the next grayscale data “G0”, the first waveform dataset is acquired by: acquiring a frame value 503 “01” for the first frame 502 (referred to as Frame 1) of the first waveform dataset from a frame lookup table 501 of Frame 1 according to the current grayscale data “G0” and the next grayscale data “G0” to generate the first piece of first waveform data 504, acquiring a frame value 503 “01” for the second frame 502 (referred to as Frame 2) of the first waveform dataset from a frame lookup table 501 of Frame 2 according to the current grayscale data “G0” and the next grayscale data “G0” to generate the second piece of first waveform data 504, . . . , and acquiring a frame value 503 “00” for the seventh frame 502 (referred to as Frame 7) of the first waveform dataset from a frame lookup table 501 of Frame 7 according to the current grayscale data “G0” and the next grayscale data “G0” to generate the seventh piece of first waveform data 504. Accordingly, the complete set of the first waveform dataset may be {“01”, “01”, “10”, “00”, “10”, “01”, “00”}.

When a complete set of first waveform data 504 has been looked up for each frame 502 (e.g., the 7 frames 502 as indicated in FIG. 4) of the first waveform dataset, one can see that the first waveform data 504 may constitute a predetermined pulse-width modulation (PWM) waveform 505 for driving the microcapsule to transform from the current grayscale level “G0” to the next grayscale level “G0”. However, this predetermined PWM waveform 505 is to be further processed so as to cut down the time (frame quantity) used on transforming the grayscale level of the microcapsule.

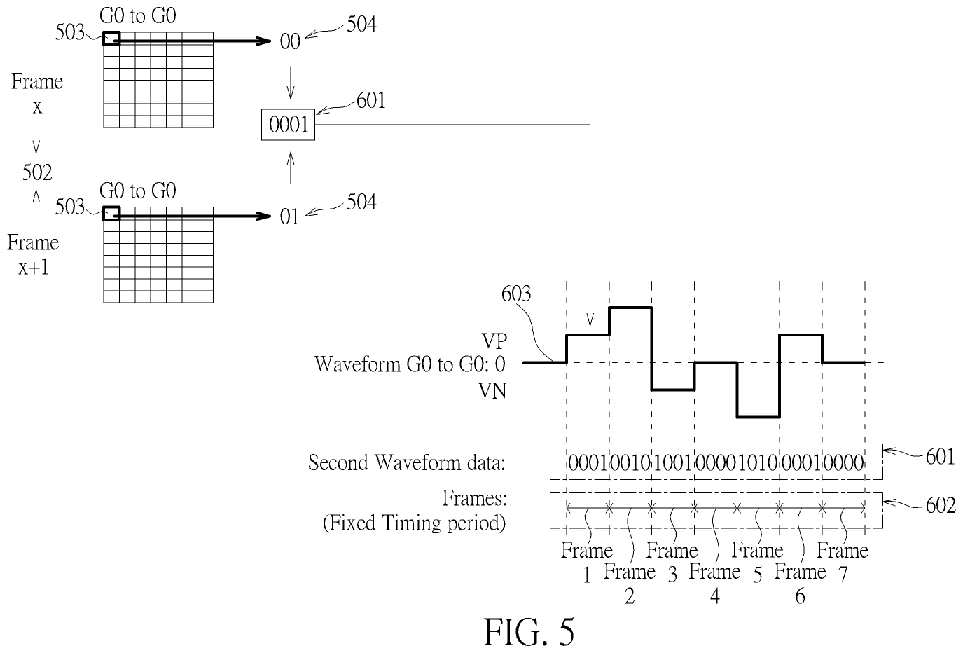

Refer back to Step S5 of FIG. 3, upon an instruction passed down by the processing unit 100, the waveform generation unit 600 generates a second waveform dataset based on the first waveform dataset, so as to further process the predetermined PWM waveform 505 indicated in the first waveform dataset and cut down the time for transforming the grayscale level of the microcapsule. Details of Step S5 are now discussed with reference to FIG. 5.

FIG. 5 shows an exemplary schematic of details regarding the second waveform dataset acquired by the waveform generation unit 600. As shown, the waveform generation unit 600 generates the second waveform dataset by selecting a predetermined number of pieces of first waveform data 504 from the first waveform dataset, where the predetermined number of the first waveform data 504 is consecutive in frame order; assembling the predetermined number of pieces of the first waveform data 504 by the frame order to obtain the assembling result; and outputting the assembling result as second waveform data 601 of the second waveform dataset, where one piece of the second waveform data 601 has a same frame duration as the fixed time duration of one frame 502 of the first waveform data 504.

In the embodiment in FIG. 5, the predetermined number can be set as 2, the selected 2 pieces of the first waveform data 504 each has 2 bits and are respectively frame values 503 “00” and “01” of the first waveform data 504 of the x^{th} and x+1^{th} frames 502, and the exemplary piece of the second waveform data 601 has 4 bits and contains an assembled data (e.g., “0001” as shown) assembled from the x^{th} and x+1^{th} frames 502 of the first waveform data 504 by following the frame order.

That is, when a complete set of second waveform data 601 is generated by the waveform generation unit 600 for each frame 602 (e.g., 7 frames 602 are indicated in FIG. 5), one can see that indicated values of the second waveform data 601 may constitute a modified PWM waveform 603 having a much dynamic range due to increased bit depth of data (i.e., each piece of the second waveform data 601 has 4 bits) compared to the first waveform data 504 (i.e., each piece of the first waveform data 504 has 2 bits). Further, since each frame 602 of the second waveform data 601 is generated with groups of two adjacent frames 502 of the first waveform data 504 and each piece of the second waveform data 601 has the same frame duration as each piece of the first waveform data 504, the result frame quantity of the second waveform data 601 will be at least a quotient result from dividing a frame quantity of the first waveform data 504 with the predetermined number of 2, meaning the required time for transforming the microcapsule from the current grayscale level to the next grayscale level based on the modified PWM waveform 603 will be at most half the amount of time required by the predetermined PWM waveform 505.

However, the present invention should not be limited by the embodiment described in FIG. 5. In some embodiments, the predetermined number may be set as any integer larger than 2 (e.g., 3) so as to assemble more pieces of first waveform data 504 (while still following the adjacent frame order) into one piece of second waveform data 601, achieving an even larger dynamic range of the modified PWM waveform 603, and cutting down even more time required to transform the microcapsule from the current grayscale level to the next grayscale level. In some other embodiments, the number of bits (bit depth) of each piece of first waveform data 504 may be set as any positive integer different from 2 bits (e.g., 1 bit or 3 bits), and the matrix in each of the frame lookup table 501 may be set as other formats (e.g., a 32×32 matrix) to represent different grayscale level image quality to be displayed by the display unit 200, so as to enable the waveform generation unit 600 to support a variety type of display requirements.

Refer back to Step S6 of FIG. 3, upon receipt of second waveform dataset from the waveform generation unit 600, the processing unit 100 drives the display unit 200 to apply various voltages to the microcapsule according to the second waveform dataset (i.e., the modified PWM waveform 603 generated by the second waveform data 601). For the predetermined number of 2, the second waveform dataset may include N/2 pieces of second waveform data, each piece of second waveform data corresponding to the frame. For example, if N=7, the first waveform dataset includes 7 pieces of first waveform data, and the second waveform dataset includes 4 (=ceiling (7/2)) pieces of second waveform data, trading off a larger dynamic range for a shorter duration of the modified PWM waveform 603. Hence, the overall time for completing image switching is decreased when the method of FIG. 3 is conducted on all microcapsules embedded in the display unit 200.

Next, the method is returned to Step S1 to wait for switching image being triggered. Or, the method may be terminated when no further switching image is triggered.

The apparatus and method for driving a display described in this invention may take first waveform data looked up from frame lookup table, assemble into a second waveform data, and drive a display unit to apply voltages to microcapsules embedded therein based on modified PWM waveforms corresponding to the second waveform data. Therefore, transformations of grayscale levels of the microcapsules may be accomplished by a more dynamic voltage waveform across a reduced frame quantity of time, and hastened image switching on electrophoretic displays may be achieved.

Moreover, the present invention also describes a computer program product being adapted to perform the method as mentioned above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for driving a display, comprising:
a display unit configured to operate a microcapsule;
an image data storage configured to store current grayscale data and next grayscale data of the microcapsule;
a lookup storage coupled to the image data storage and configured to look up a first waveform dataset corresponding to the current grayscale data and the next grayscale data;
a waveform generation unit coupled to the lookup storage and configured to generate a second waveform dataset based on the first waveform dataset; and
a processing unit coupled to the image data storage, the waveform generation unit and the display unit, and configured to drive the display unit to apply a voltage to the microcapsule according to the second waveform dataset.

2. The apparatus of claim 1, wherein the waveform generation unit:
selects a predetermined number of pieces of first waveform data from the first waveform dataset, wherein the predetermined number of pieces of the first waveform data is consecutive in frame order,
assembles the predetermined number of the first waveform data by the frame order to obtain an assembling result, and
outputs the assembling result as a piece of second waveform data of the second waveform dataset.

3. The apparatus of claim 2, wherein a frame quantity of the second waveform data is at least a quotient result from dividing a frame quantity of the first waveform data with the predetermined number.

4. The apparatus of claim 3, wherein
the predetermined number is 2, and
each piece of the second waveform data has a same frame duration as each piece of the first waveform data.

5. The apparatus of claim 1, wherein one piece of second waveform data in the second waveform dataset has 4 bits.

6. The apparatus of claim 5, wherein one piece of first waveform data in the first waveform dataset has 2 bits.

7. The apparatus of claim 1, wherein
the lookup storage stores a frame lookup table corresponding to a frame, and
the lookup storage
acquires a frame value of the frame of the first waveform dataset from the frame lookup table according to the current grayscale data and the next grayscale data, and
outputs the frame value as first waveform data of the first waveform dataset.

8. A method for driving a display, comprising:
providing the apparatus for driving the display as described in claim 1; and
configuring the display unit to operate the microcapsule according to the current grayscale data.

9. The method of claim 8, further comprising:
configuring the lookup storage to look up the first waveform dataset corresponding the current grayscale data and the next grayscale data;
configuring the waveform generation unit to generate the second waveform dataset based on the first waveform dataset; and
configuring the processing unit to drive the display unit to apply voltage to the microcapsule according to the second waveform dataset.

10. The method of claim 9, wherein the step of configuring the waveform generation unit to generate the second waveform dataset based on the first waveform dataset comprises:
selecting a predetermined number of pieces of first waveform data from the first waveform dataset, the predetermined number of pieces of the first waveform data is consecutive in frame order;
assembling the predetermined number of pieces of the first waveform data by the frame order to obtain an assembling result; and
outputting the assembling result as a piece of second waveform data of the waveform dataset.

11. The method of claim 10, wherein a frame quantity of the second waveform data is at least a quotient result from dividing a frame quantity of the first waveform data with the predetermined number.

12. The method of claim 10, wherein
the predetermined number is 2, and
each piece of the second waveform data has the same frame duration as each piece of the first waveform data.

13. The method of claim 9, wherein one piece of second waveform data in the second waveform dataset has 4 bits.

14. The method of claim 13, wherein one piece of first waveform data in the first waveform dataset has 2 bits.

15. The method of claim 9, wherein
the lookup storage stores a frame lookup table corresponding to a frame, and
the step of the lookup storage looks up the first waveform dataset corresponding to the current grayscale data and the next grayscale data comprises:
acquiring a frame value of the frame of the first waveform dataset from the frame lookup table according to the current grayscale data and the next grayscale data; and
outputting the frame value as first waveform data of the first waveform dataset.

16. A computer program product adapted to perform the method as described in claim 8.
